(19) United States
(12) Patent Application Publication
(10) Pub. No.: US 2006/0198375 A1
(43) Pub. Date: Sep. 7, 2006

(54) Method and apparatus for pattern matching based on packet reassembly

(76) Inventors: Kwang Ho Baik, Daejeon-city (KR); Jin Tae Oh, Daejeon-city (KR); Ki Young Kim, Daejeon-city (KR); Jong Soo Jang, Daejeon-city (KR); Sung Won Sohn, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/269,340

(22) Filed: Nov. 7, 2005

(30) Foreign Application Priority Data
Dec. 7, 2004 (KR) 10-2004-0102392
Jun. 23, 2005 (KR) 10-2005-0054370

(51) Int. Cl. H04J 1/16; H04L 12/56

(52) U.S. Cl. 370/392; 370/252

(57) ABSTRACT

A method and apparatus for pattern matching using packet reassembly are provided. The pattern matching method using packet reassembly includes: extracting serial information in relation to a current input packet; determining whether or not pattern matching result information in relation to one or more previous packets and/or subsequent packets on the basis of the serial number of the current input packet is already stored; loading the pattern matching result information in relation to the previous packets and/or subsequent packets; and reassembling the loaded pattern matching result information in relation to the previous packets and/or subsequent packets and the current input packet and performing pattern matching with attack patterns which are already stored. Accordingly, by using packet reassembly, a method and apparatus for pattern matching capable of reducing memory usage without lowering the speed can be provided

### CROSS-REFERENCE TO RELATED PATENT APPLICATIONS

This application claims the benefit of Korean Patent Application Nos. 10-2004-0102392, filed on Dec. 7, 2004 and 10-2005-0054370, filed on 23 Jun. 2005, in the Korean Intellectual Property Office, the disclosures of which are incorporated herein in their entirety by reference.

### BACKGROUND OF THE INVENTION

1. Field of the Invention

The present invention relates to a pattern matching method using packet reassembly and an apparatus therefor, and more particularly, to a pattern matching method providing a packet reassembly function with minimum hardware resources as a base technology for real-time network intrusion detection in a giga scale network, and an apparatus therefor.

2. Description of the Related Art

Since the 1980s, a variety of intrusion detection systems have been developed to protect information systems. Intrusion into an information system can be defined as trying to access an information system with an illegal intention, to manipulate information or disable the system.

Due to the rapid expansion of the Internet since the 1990s, the objects of intrusion have been expanding from a single information system to the entire network.

In the 2000s, intrusions targeting information systems have become more intelligent and much faster. Unlike the past intrusion type targeting only a single information system, attacks stopping the network service itself by disabling the entire network are becoming more common.

Since intrusion methods are becoming more intelligent and network bandwidth is continuously increasing, a lot of current research focuses on making much faster and more accurate intrusion detection systems for protecting networks.

In particular, a real-time countermeasure technology against intrusion has been established as an essential function of a network intrusion detection system. The real-time countermeasure technology detects and responds in real time to an attack on a network.

As a result of the research, a variety of intrusion detection systems, such as RealSecure of ISS, IntruShield of McAfee, etc., have been installed to function in a network.

At present, the most effective intrusion detection method is a rule-based intrusion detection method. In this method, by analyzing known attacks and generating attack patterns based on the analysis, all packets passing through a network are compared with the attack patterns to determine whether or not there is an intrusion. This method is effective against known intrusions.

One core technology required for this rule-based intrusion detection method is pattern matching technology. The pattern matching technology examines whether or not a packet passing through a network includes a pattern specified in an intrusion detection rule. This is one of the most important intrusion detection technologies.

It is difficult to apply this pattern matching technology to a high-speed network by a software method because of the complexity of searching and speed reduction with increasing rules. Also, in the case of a hardware method, high speed implementation is difficult due to the limited hardware resources.

In order to solve these difficulties, much research is underway for the pattern matching technology, and in particular, a variety of studies on hardware-based pattern matching are being conducted. Implementation of the pattern matching technology in a giga scale network can be regarded as a core issue in the development of an intrusion detection system.

However, in the situation where the intrusion method of networks becomes more intelligent and more attacks avoid an intrusion detection system using IP fragmentation and/or TCP segmentation, the conventional rule-based intrusion detection method cannot cope with attacks without a pattern matching technology which can reassemble IP fragmented and TCP segmented packets.

In addition, if the rule-based intrusion detection method does not reassemble all packets passing through a network, the method cannot cope with an attack which avoids an intrusion detection system using this IP fragmentation or TCP segmentation. Accordingly, in order to detect this type of attack, providing a packet reassembly function to a high-speed hardware-based pattern matching technology has been emerging as an important research subject.

FIG. 1 illustrates a conventional TCP reassembly method for a TCP/IP packet and FIG. 2 illustrates a conventional IP de-fragmentation method for an IP packet. Referring to FIGS. 1 and 2, dividing a packet in the IP layer is referred to as IP fragmentation, and dividing a packet in the TCP layer is referred to as TCP segmentation. Reassembling the divided packets is referred to respectively as IP de-fragmentation and TCP reassembly. Also, IP de-fragmentation and TCP reassembly are collectively referred to as packet reassembly.

The core part of IP de-fragmentation and TCP reassembly is reassembling the payloads of continuous packets based on the fragment offset of an IP header or the sequence number of a TCP header. Generally, IP de-fragmentation and TCP reassembly are performed in the host of a destination. If the reassembly function is not supported, attacks avoiding intrusion detection using reassembly cannot be blocked. However, an intrusion detection system does not need to perform the same reassembly process as that performed by the destination host. Since pattern matching is performed in relation to each packet, reassembly is only necessary when an attack pattern is separated between packets.

FIG. 3 illustrates a conventional packet reassembly method. Referring to FIG. 3, the method is to find a case where an attack pattern is dispersed in continuous packets. Here, the continuous packets are not continuous in time, but are continuous in the sequence number of the TCP header or in the fragment offset of the IP header on the basis of packet reassembly. Continuous packets as shown in FIG. 3 must be examined on the basis of a maximum intrusion pattern length (maximum rule pattern length, RLmax). That is, in the case of two continuous packets, it is necessary to reassemble and examine data with a length of about twice the maximum intrusion pattern length.

However, in the case of packet reassembly for pattern matching there is a problem no less important than the length of data to be reassembled. In order to reassemble continuous packets and perform pattern matching, previous packet data should be stored in a storage unit before a next packet comes in.

In addition, there is no guarantee of sequential arrival of a TCP header in order of sequence number, or of an IP header in order of fragment offset. Accordingly, at high network bandwidths, the amount of packet data that must be stored in a memory for reassembly increases. In particular, when hardware is used in order to detect intrusion in a high speed network, this increase in memory can be a serious constraint.

The increase in the amount of packet data for reassembly is not limited to simple increases of the memory to be used. That is, the increase of the amount of packet data may make functions related to data processing more complicated, and this means an increase in the processing time. In particular, in the case of a high speed network being a target, the increase in the processing time can greatly degrade the performance of an intrusion detection system.

### SUMMARY OF THE INVENTION

The present invention provides a pattern matching method and apparatus using packet reassembly to overcome the limit of hardware resources by using the pattern matching result in relation to each packet in reassembly in order to utilize resources efficiently.

According to an aspect of the present invention, there is provided a pattern matching apparatus using packet reassembly, including: a storage unit which stores pattern matching result information which is generated when an input packet matches a part of an attack pattern; a pattern matching unit which, if one or more packets previous to a current input packet and/or packets subsequent to the current packet on the basis of the serial number of the current input packet are received, reassembles pattern matching result information in relation to previous and/or subsequent packets and the current in put packet and performs pattern matching with attack patterns already stored; and a packet reassembly function unit which determines whether or not the pattern matching result information in relation to the packets previous to an/or subsequent to the current in put packet is already stored in the storage unit, and transmits the pattern matching result information to the pattern matching unit.

According to another aspect of the present invention, there is provided a pattern matching method using packet reassembly, including: extracting serial information in relation to a current input packet; determining whether or not pattern matching result information in relation to at least one or more previous packets and/or subsequent packets on the basis of the serial number of the current input packet is already stored; if it is determined that any one of pattern matching result information items in relation to at least one or more previous packets and/or subsequent packets of the current input packet is already stored, loading the pattern matching result information in relation to the previous packets and/or subsequent packets; and reassembling the loaded pattern matching result information in relation to the previous packets and/or subsequent packets and the current input packet and performing pattern matching with already stored attack patterns.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional TCP reassembly method for a TCP/IP packet;

FIG. 2 illustrates a conventional IP de-fragmentation method for an IP packet;

FIG. 3 illustrates a conventional packet reassembly method;

FIG. 4 is a block diagram of a pattern matching apparatus using packet reassembly according to an embodiment of the present invention;

FIG. 5 is a schematic diagram showing packet reassembly performed in a pattern matching unit of FIG. 4; and

FIG. 6 is a flowchart of the operations performed by a pattern matching method using packet reassembly according to an embodiment of the present invention.

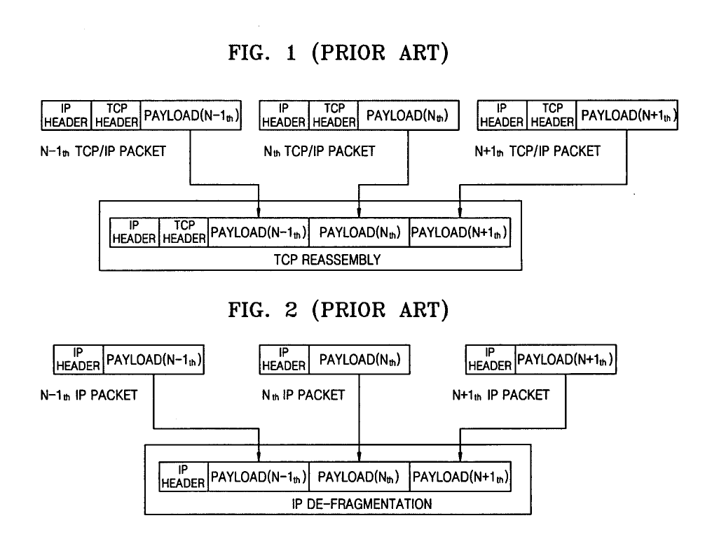

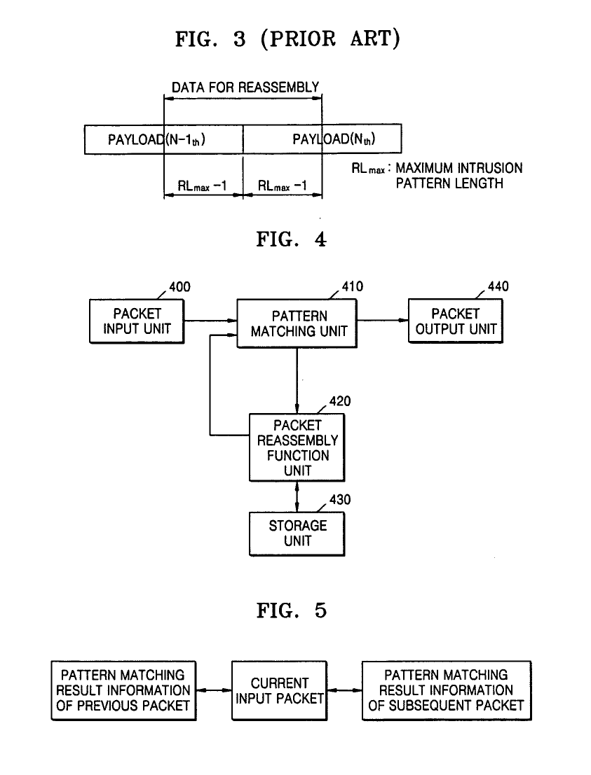

### DETAILED DESCRIPTION OF THE INVENTION

The present invention will now be described more fully with reference to the accompanying drawings, in which exemplary embodiments of the invention are shown.

FIG. 4 is a block diagram of a pattern matching apparatus using packet reassembly according to an embodiment of the present invention. Referring to FIG. 4, the pattern matching apparatus using packet reassembly includes a packet input unit 400, a pattern matching unit 410, a packet reassembly function unit 420, a storage unit 430, and a packet output unit 440.

The packet input unit 400 receives a packet from a source system transmitting the packet through a network, and transmits the packet to the pattern matching unit 410.

The pattern matching unit 410 performs a pattern matching operation with the packet input from the packet input unit 400. Here, pattern matching means to examine the packet input from the packet input unit 400 by comparison with a plurality of attack patterns already set as intrusion rules in the pattern matching unit 410, and determine whether there is a match. More specifically, for example, if the pattern matching unit 410 receives a current input packet from the packet input unit 400, the pattern matching unit 410 transmits the serial number of the current input packet to the packet reassembly function unit 420.

In the packet reassembly function unit 420, with the serial number of the current input packet transmitted by the pattern matching unit 410, it is determined whether or not pattern matching result information of the previous packet and subsequent packet is already stored in the storage unit 430. Here, if it is determined that the pattern matching result information of the previous packet and subsequent packet in relation to the current input packet is already stored in the storage unit 430, the packet reassembly function unit 420 loads the corresponding pattern matching result information from the storage unit 430 and transmits to the pattern matching unit 410.

Here, the previous packet and subsequent packet of the current input packet are not adjacent in time, but are adjacent in order of sequence number of the TCP header or of fragment offset of the IP header on the basis of packet reassembly. Also, the previous packet or subsequent packet of the current input packet is not limited to a physically single packet, but can include a plurality of previous packets or subsequent packets.

Meanwhile, if it is determined that there is no corresponding pattern matching result information, the packet reassembly function unit 420 transmits to the pattern matching unit a message indicating that there is no pattern matching result information.

The storage unit 430 stores the pattern matching result information, according to the control of the packet reassembly function unit 420, and also transmits the corresponding pattern matching result information to the packet reassembly function unit 420.

Unlike the conventional packet reassembly, the storage unit 430 does not need to store packet data in a memory, but stores only the pattern matching result information in relation to the packet and uses this for pattern matching of the next input packet. This allows the same result as reassembling packet data and performing pattern matching for all the data.

Accordingly, in FIG. 4, if the patterns match, only pattern matching result information is stored in the storage unit 430, and if an adjacent packet is received, and the information is called and used for pattern matching, then the reassembly function for pattern matching can be implemented with less memory and a simple hardware structure.

In the pattern matching unit 410, if any of the pattern matching result information on the previous packet and the subsequent packet is received from the packet reassembly function unit 420, the received pattern matching result information and the current input packet are reassembled, and pattern matching is performed with predetermined attack patterns already stored.

Meanwhile, in the pattern matching unit 410, if none of the pattern matching result information on the previous packet and the subsequent packet is received from the packet reassembly function unit 420, pattern matching is performed only with the current input packet with predetermined attack patterns already stored.

Here, if patterns do not match as the result of performing pattern matching in the pattern matching unit 410, the packet input from the packet input unit 400 is output to the packet output unit 440. Then, in the packet output unit 440 the packet input from the pattern matching unit 410 is transmitted to the destination system through a network. Also, if the packet matches a part of a predetermined attack pattern as the result of performing pattern matching, the pattern matching unit 410 transmits the pattern matching result information on the current input packet to the packet reassembly function unit 420. The packet reassembly function unit 420 stores the pattern matching result information on the current input packet in the storage unit 430.

Meanwhile, if the packet matches an entire predetermined attack pattern as the result of performing pattern matching, the pattern matching unit 410 performs a preset countermeasure against the current input packet, such as blocking transmission of the current input packet to the packet output unit 440.

As a first example, assuming that the serial number of a current input packet is N, a case where the current input packet N is input from the packet input unit 400 and pattern matching result information on packet (N+1) (a packet subsequent to the current input packet) is not stored, and pattern matching result information on packet (N−1) (a packet previous to the current input packet) is already stored, will now be explained. Here, the packet (N−1) previous to the current input packet or the packet (N+1) subsequent to the current input packet is not limited to a physically single packet, but may include a plurality of packets.

The pattern matching unit 410 receives the transmitted packet N through the packet input unit 400.

Next, the pattern matching unit 410 transmits the serial number of the current input packet N to the packet reassembly function unit 420 in order to notify that the current input packet N is received.

Next, the packet reassembly function unit 420 determines whether or not pattern matching result information in relation to the packet (N−1) previous to the current input packet and the packet (N+1) subsequent to the current input packet is already stored in the storage unit 430, loads the pattern matching result information on the packet (N−1) already stored in the storage unit 430, and transmits the information to the pattern matching unit 410.

If the pattern matching result information on the packet (N−1) is received, the pattern matching unit 410 reassembles the pattern matching result information on the packet (N−1) and the current input packet N, and performs pattern matching with predetermined attack patterns already stored. In this case, the result will be the same as that obtained by reassembling the packet (N−1) and the packet N data and performing pattern matching for all the data.

If patterns do not match as the result of the pattern matching, the pattern matching unit 410 transmits the packet N input from the packet input unit 400 to a destination system to which the packet will be transmitted, through the packet output unit 440.

Also, if the packet matches a part of a predetermined attack pattern as the result of performing pattern matching, the pattern matching unit 410 transmits the pattern matching result information on the packet N to the packet reassembly function unit 420. The packet reassembly function unit 420 stores the pattern matching result information of the packet N in the storage unit 430.

Meanwhile, if the packet matches an entire predetermined attack pattern as the result of performing pattern matching, the pattern matching unit 410 performs a preset countermeasure against the current input packet, such as blocking transmission of the current input packet to the packet output unit 440.

As a second example, assuming that a current input packet is N, a case where pattern matching result information on packet (N−1) is not stored in the storage unit 430 and only pattern matching result information on packet (N+1) is already stored will now be explained. Here, the packet (N−1) previous to the current input packet or the packet (N+1) subsequent to the current input packet is not limited to a physically single packet, but may include a plurality of packets.

The pattern matching unit 410 receives the transmitted packet N through the packet input unit 400.

Next, the pattern matching unit 410 transmits the serial number of the current input packet N to the packet reassembly function unit 420 in order to notify that the current input packet N is received.

Next, the packet reassembly function unit 420 determines whether or not pattern matching result information in relation to the packet (N−1) previous to the current input packet and the packet (N+1) subsequent to the current input packet is already stored in the storage unit 430, loads the pattern matching result information on the packet (N+1) already stored in the storage unit 430, and transmits the information to the pattern matching unit 410.

If the pattern matching result information on the packet (N+1) is received, the pattern matching unit 410 reassembles the pattern matching result information on the packet (N+1) and the current input packet N, and performs pattern matching with predetermined attack patterns already stored. In this case, the result will be the same as that obtained by reassembling the packet N and the packet (N+1) data and performing pattern matching for all the data.

If patterns do not match as the result of the pattern matching, the pattern matching unit 410 transmits the packet N input from the packet input unit 400, to a destination system to which the packet will be transmitted, through the packet output unit 440.

Also, if the packet matches a part of a predetermined attack pattern as the result of performing pattern matching, the pattern matching unit 410 transmits the pattern matching result information on the packet N to the packet reassembly function unit 420. The packet reassembly function unit 420 stores the pattern matching result information of the packet N in the storage unit 430.

Meanwhile, if the packet matches an entire predetermined attack pattern as the result of performing pattern matching, the pattern matching unit 410 performs a preset countermeasure against the current input packet, such as blocking transmission of the current input packet to the packet output unit 440.

As a third example, assuming that a current input packet is N, a case where both pattern matching result information on packet (N−1) and pattern matching result information on packet (N+1) are already stored in the storage unit 430 can be understood by referring to the first and second examples. Here, the packet (N−1) previous to the current input packet or the packet (N+1) subsequent to the current input packet is not limited to a physically single packet, but may include a plurality of packets.

As a fourth example, assuming that a current input packet is N, a case where both pattern matching result information on packet (N−1) and pattern matching result information on packet (N+1) are not already stored in the storage unit 430 will now be explained. Here, the packet (N−1) previous to the current input packet or the packet (N+1) subsequent to the current input packet is not limited to a physically single packet, but may include a plurality of packets.

The pattern matching unit 410 receives the transmitted packet N through the packet input unit 400.

Next, the pattern matching unit 410 transmits the serial number of the current input packet N to the packet reassembly function unit 420 in order to notify that the current input packet N is received.

Next, the packet reassembly function unit 420 determines whether or not pattern matching result information in relation to the packet (N−1) previous to the current input packet and the packet (N+1) subsequent to the current input packet is already stored in the storage unit 430, and transmits a message to the pattern matching unit 410 in order to notify that both pattern matching result information on packet (N−1) and pattern matching result information on packet (N+1) are not already stored in the storage unit 430.

Since pattern matching result information on packet (N−1) and pattern matching result information on packet (N+1) are not in the storage unit 430, the pattern matching unit 410 performs pattern matching of the current input packet N with predetermined attack patterns already stored.

If patterns do not match as the result of the pattern matching of the current input packet N, the pattern matching unit 410 transmits the packet N input from the packet input unit 400, to a destination system to which the packet will be transmitted, through the packet output unit 440.

Also, if the packet matches a part of a predetermined attack pattern as the result of performing pattern matching of the current input packet N, the pattern matching unit 410 transmits the pattern matching result information on the packet N to the packet reassembly function unit 420. The packet reassembly function unit 420 stores the pattern matching result information of the packet N in the storage unit 430.

Meanwhile, if the packet matches an entire predetermined attack pattern as the result of performing pattern matching, the pattern matching unit 410 performs a preset countermeasure against the current input packet, such as blocking transmission of the current input packet to the packet output unit 440.

FIG. 5 is a schematic diagram showing packet reassembly performed in the pattern matching unit 410 of FIG. 4. Referring to FIG. 5, packet reassembly performed in the pattern matching unit 410 in the case of the third example described above is shown. That is, in this case, assuming that a current input packet is N, both pattern matching result information on packet (N−1) and pattern matching result information on packet (N+1) are already stored in the storage unit 430. Though the case where the pattern matching result information of both the packet (N−1) and the packet (N+1) is stored is shown in FIG. 5, in another example of the present invention there can be a case where there is only one of the pattern matching result information of the packet (N−1) and the packet (N+1). Also, in still another example of the present invention, there may be a case where there is neither of the pattern matching result information of the packet (N−1) and the packet (N+1). In this case, the pattern matching unit 410 does not perform packet reassembly, only pattern matching of the current input packet N.

Here, the packet (N−1) previous to the current input packet or the packet (N+1) subsequent to the current input packet is not limited to a physically single packet, but may include a plurality of packets.

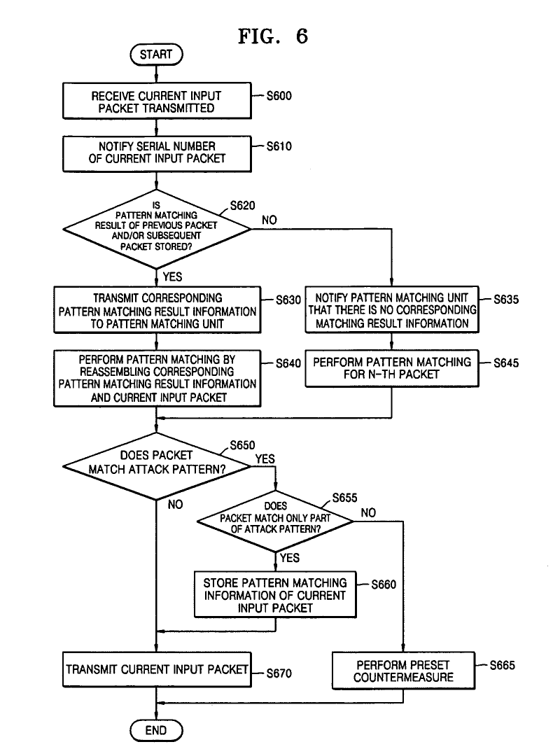

FIG. 6 is a flowchart of the operations performed by a pattern matching method using packet reassembly according to an embodiment of the present invention. Referring to FIG. 6, first, the pattern matching unit 410 receives a transmitted current input packet from the packet input unit 400 in operation S600.

Next, the pattern matching unit 410 notifies the packet reassembly function unit 420 of the serial number of the current input packet in operation S610.

Next, the packet reassembly function unit 420 determines whether or not pattern matching result information of a packet previous to the current input packet and/or a packet subsequent to the current packet is already stored in the storage unit 430 in operation S620. Here, the previous packet and subsequent packet of the current input packet are not adjacent in time, but are adjacent in order of sequence number of the TCP header or of fragment offset of the IP header on the basis of packet reassembly. Also, the previous packet or subsequent packet of the current input packet is not limited to a physically single packet, but can include a plurality of previous packets or subsequent packets.

If the determination result of operation S620 indicates that pattern matching result information of the packet previous to the current input packet and/or the packet subsequent to the current packet are already stored in the storage unit, the packet reassembly function unit 420 transmits the pattern matching result information to the pattern matching unit 410 in operation S630.

After operation S630, the pattern matching unit 410 reassembles the pattern matching result information input in operation S630 and the current input packet input from the packet input unit 400 in operation S600, and performs pattern matching with preset predetermined attack patterns in operation S640. Meanwhile, if the result of determination in operation S620 indicates that pattern matching result information of the packet previous to the current input packet and/or the packet subsequent to the current packet are not stored in the storage unit, the pattern reassembly function unit 420 transmits to the pattern matching unit 410 a message indicating that there is no corresponding pattern matching result information in operation S635.

After operation S635, the pattern matching unit 410 performs pattern matching of the current input packet input from the packet input unit 400 in operation S600 with preset attack patterns in operation S645. After operations S640 and S645, it is determined whether or not the packet matches attack patterns as the result of performing pattern matching in operation S650.

If the result of determination in operation S650 indicates that the packet matches an attack pattern, it is further determined whether or not the packet matches only a part of the attack pattern or the entire attack pattern in operation S655.

If the result of determination in operation S655 indicates that the packet matches only a part of the attack pattern, the pattern matching unit 410 stores the pattern matching result information of the current input packet in operation S660.

Meanwhile, if the result of determination in operation S655 indicates that the packet matches the entire attack pattern, the preset countermeasure is performed in operation S665, such as blocking transmission of the current input packet. If the result of determination in operations S660 and S650 indicates that the packet does not match any attack patterns, operation S670 is performed such that the current input packet is output to the destination system through the packet output unit 440.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

The present invention relates to a packet reassembly method and apparatus, and by providing a packet reassembly function to a high speed pattern matching system for real-time intrusion detection in a giga scale network, allows the detection of intrusion using IP fragmentation and TCP segmentation.

Also, the present invention enables the packet reassembly function with minimum resources in a high speed pattern matching system implemented in hardware with limited resources, such that a wider range of attacks can be prevented. In particular, since only minimum memory resources are used, the packet reassembly function can be performed in a high speed intrusion detection system.

What is claimed is:

1. A pattern matching apparatus using packet reassembly, comprising:
a storage unit which stores pattern matching result information generated when an input packet matches a part of an attack pattern;
a pattern matching unit which, if one or more packets previous to a current input packet and/or packets subsequent to the current packet on the basis of the serial number of the current input packet are received, reassembles pattern matching result information in relation to previous and/or subsequent packets and the current input packet and performs pattern matching with attack patterns already stored; and
a packet reassembly function unit which determines whether or not the pattern matching result information in relation to the packets previous to and/or subsequent to the current input packet is already stored in the storage unit, and transmits the pattern matching result information to the pattern matching unit.

2. The apparatus of claim 1, wherein if the pattern matching result information in relation to the previous packets and/or subsequent packets on the basis of the serial number of the current input packet from the packet reassembly function unit is not received, the pattern matching unit performs pattern matching of only the current input packet.

3. The apparatus of claim 2, wherein if it is determined that there is no pattern matching result information in relation to the previous packets and/or subsequent packets on the basis of the serial number of the current input packet, the packet reassembly function unit transmits to the pattern matching unit a message indicating that there is no pattern matching result information.

4. The apparatus of claim 1, wherein if the result of performing pattern matching indicates that the packet matches the entire attack pattern, the pattern matching unit processes the current input packet according to a preset countermeasure.

5. The apparatus of claim 4, wherein the preset countermeasure is to block the output of the current input packet.

6. The apparatus of claim 1, wherein if as the result of performing pattern matching the current input packet matches a part of the attack pattern, the pattern matching unit stores the pattern matching result information in relation to the current input packet in the storage unit.

7. The apparatus of claim 1, wherein if the result of performing pattern matching indicates that the packet does not match any attack pattern, the pattern matching unit outputs the current input packet.

8. The apparatus of claim 1, wherein the serial number of the current input packet is a sequence number of TCP segmentation.

9. The apparatus of claim 1, wherein the serial number of the current input packet is an IP fragmentation offset.

10. The apparatus of claim 1, wherein the previous packets and/or subsequent packets include one previous packet and/or one subsequent packet.

11. A pattern matching method using packet reassembly, comprising:
extracting serial information in relation to a current input packet;
determining whether or not pattern matching result information in relation to one or more previous packets and/or subsequent packets on the basis of the serial number of the current input packet is already stored;
if it is determined that pattern matching result information in relation to one or more previous packets and/or subsequent packets of the current input packet is already stored, loading the pattern matching result information in relation to the previous packets and/or subsequent packets; and
reassembling the loaded pattern matching result information in relation to the previous packets and/or subsequent packets and the current input packet and performing pattern matching with already stored attack patterns.

12. The method of claim 11, wherein in the loading of the pattern matching result information, if it is determined that pattern matching result information in relation to one or more previous packets and/or subsequent packets of the current input packet is not already stored, generating a message indicating that there is no pattern matching result information in relation to the previous packets and/or subsequent packets.

13. The method of claim 12, wherein in the reassembling and the performing of the pattern matching, if the message indicating that there is no pattern matching result information in relation to the previous packets and/or subsequent packets is generated, performing the pattern matching of only the current input packet.

14. The method of claim 11, wherein if as a result of performing the pattern matching, the entire attack pattern is sensed, processing the current input packet according to a preset countermeasure.

15. The method of claim 14, wherein the preset countermeasure is to block the output of the current input packet.

16. The method of claim 11, further comprising, if as the result of performing the pattern matching, a part of the attack pattern is sensed, storing the pattern matching result information in relation to the current input packet.

17. The method of claim 11, further comprising, if as the result of performing the pattern matching, no attack pattern is sensed, outputting the current input packet.

18. The method of claim 11, wherein the serial number of the current input packet is a sequence number of TCP segmentation.

19. The method of claim 11, wherein the serial number of the current input packet is an IP fragmentation offset.

20. The method of claim 11, wherein the previous packets and/or subsequent packets comprises one previous packet and/or subsequent packet.
